(19) United States
(12) Patent Application Publication
(10) Pub. No.: US 2007/0224872 A1
(43) Pub. Date: Sep. 27, 2007

(54) INTEGRAL BONDING ATTACHMENT

(75) Inventors: David Charles Cecil, Saint Augustine, FL (US); Jack Edgar Sutherland, Saint Augustine, FL (US)

Correspondence Address: WOOD, HERRON & EVANS, LLP, 2700 CAREW TOWER, 441 VINE STREET, CINCINNATI, OH, 45202, US

(73) Assignee: TENSOLITE COMPANY, Saint Augustine, FL (US)

(21) Appl. No.: 11/754,534

(22) Filed: May 29, 2007

Related U.S. Application Data
(62) Division of application No. 11/315,456, filed on Dec. 22, 2005, now Pat. No. 7,241,185.

(51) Int. Cl. H01R 4/24

(52) U.S. Cl. 439/402

(57) ABSTRACT

An integral bonding attachment includes an insulated section of a conductive wire with an exposed, uninsulated section. A sleeve covers the insulated and uninsulated sections of the conductive wire, and the sleeve includes a flattened section encasing at least a portion of the uninsulated wire section to form a generally integral structure with the core of the conductive wire. At least one generally tubular section is positioned at an end of the flattened section to engage the insulated section of the conductive wire. An aperture may pass simultaneously through the inner core and flattened sleeve section for attaching the integral bonding attachment to a structure.

### RELATED APPLICATION

This application is a Divisional application of U.S. patent application Ser. No. 11/315,456 filed Dec. 22, 2005 and entitled “Integral Bonding Attachment”, which application is incorporated herein by reference in its entirety.

### FIELD OF THE INVENTION

The present invention is directed to devices for connecting and securing a conductor or wire to a support structure, and particularly, but not exclusively, to an integral bonding attachment for connecting a conductive wire to a support surface in the construction of an aircraft.

### BACKGROUND OF THE INVENTION

During the construction of many different structures, such as airplanes, it is necessary to provide suitable grounding for the electronics and electrical systems. It is particularly critical for airplane construction, because airplanes, in addition to requiring a robust ground reference for their electrical systems, are also subject to outside electrical phenomenon, such as lighting and stray electromagnetic energy (EME), such as from radars or the like. In the past, the metallic wing structure of an airplane provided a grounding system and overall attachment point for ground references. However, with the advent and growing popularity of composite wing structures, it has been necessary to provide an alternate grounding system.

Currently, the airplane frame is used to provide a grounding reference and an attachment point for various ground busses in the electrical system of the aircraft. The most common method for making such a connection is to use a lug. A lug is a device having an open end or sleeve for receiving an end of a tubular wire or other conductor. The other end is a flattened portion with a hole to connect the lug to a flat surface. The sleeve of the lug is slid over the end of the tubular conductor and then a crimping pliers, an adhesive, welding, or other similar techniques are used to connect the lug to the conductor. The lug is thus attached to the conductor and the flat end is positioned to rest upon the flat surface of a frame portion or other support structure. The hole in the flat surface enables a fastener or bolt to pass through to firmly fix the tubular structure to the flat surface.

Traditional lugs have many drawbacks. First, a weakness exists between the conductor cable and the open end or sleeve of the lug. For example, the conductor may pull out of the lug. Furthermore, the stress on the conductor at the crimp might cause the conductor to break at that point. Additionally, potential for less than optimal performance exists. Oftentimes, the lug is made of a different metal than the conductor and corrosion may occur between the dissimilar metals. Also, the crimpled lug may not provide a good low resistance or low impedance path through the end of the conductor. Still further, for attachment of the lugs along a long length of cable, it is necessary to cut the cable, attach two lugs to the cut end, and then bolt the two lugs to the frame or other structural element. As may be appreciated, such additional steps are time consuming and costly. Also, as may be appreciated, it is undesirable to provide a break or cut in the length of the cable.

Therefore, many needs exist in this area of technology, particularly with respect to providing a robust ground reference in an airplane.

### SUMMARY OF THE INVENTION

One embodiment of the invention includes an integral bonding attachment for connecting a conductive wire to an attachment surface, such as a grounding surface. The integral bonding attachment includes an insulated section of the conductive wire, an uninsulated section of the conductive wire integrally formed with the insulated section, and a sleeve covering at least a portion of the uninsulated section of the conductive wire. In one embodiment the sleeve covers the insulated and uninsulated sections. The sleeve includes a flattened section encasing at least a portion of the uninsulated section and at least one generally tubular section positioned at an end of the flattened section. Apertures may be formed through the flattened section and the conductive wire section.

In one embodiment of the invention, the integral bonding attachment is formed along an unbroken conductive wire. The flattened section encases an unbroken and uninsulated section of the wire. In another embodiment, the integral bonding attachment is used at the end of a wire. In either case, the uninsulated section of the wire is integrally formed with the flattened section that is attached to an attachment surface, such as an electrical ground source.

Another aspect of the invention is a method of forming an integral bonding attachment. The method includes providing a conductive wire having an insulated section and an uninsulated section, and sliding a sleeve over at least a portion of the uninsulated section of the conductive wire. The sleeve is compressed simultaneously with the uninsulated section of wire produce the flattened section while maintaining a tubular section positioned at an end of the flattened section to engage the insulated section of wire. One or more apertures may be formed through the flattened section.

### BRIEF DESCRIPTION OF THE DRAWINGS

FIG. 1 illustrates a perspective view of an integral bonding attachment according to one embodiment of the invention.

FIG. 2 illustrates a side elevation view of an insulated conductive wire having an exposed section where the insulation has been removed.

FIG. 3 illustrates a partial cross sectional side elevation view of the conductive wire of FIG. 2 with the addition of a sleeve and two shrink tubes.

FIG. 4 illustrates a partial cross sectional side elevation view of the conductive wire of FIG. 3 with a section of the sleeve and the uninsulated section of the conductive wire being flattened.

FIG. 5 illustrates a partial cross sectional side elevation view of the conductive wire of FIG. 4 with two apertures formed simultaneously through the flattened section of the sleeve and the conductive wire and the shrink tubes formed to complete the embodiment of the integral bonding attachment illustrated in FIG. 1.

FIG. 6 illustrates a side elevation view of the integral bonding attachment of FIG. 5 being connected to a structure.

FIG. 7 illustrates a side elevation view of conductive wire having an exposed end section that is not insulated.

FIG. 8 illustrates a partial cross sectional side elevation view of the conductive wire of FIG. 7 with a sleeve placed around the exposed section of the conductive wire.

FIG. 9 illustrates a partial cross sectional side elevation view of the conductive wire of FIG. 8 with a portion of the sleeve and the uninsulated section of the conductive wire being flattened.

FIG. 10 illustrates a partial cross sectional side elevation view of the conductive wire of FIG. 9 with apertures formed simultaneously through the flattened section of the conductive wire and the sleeve and the shrink tube formed to complete the embodiment of the integral bonding attachment.

FIG. 11 illustrates a side elevation view of the integral bonding attachment of FIG. 10 connected to a structure.

FIG. 12 illustrates a top plan view of the integral bonding attachment of FIG. 1.

FIG. 13 illustrates a cross-sectional side elevation view of the integral bonding attachment of FIG. 1.

FIG. 14 a partial cross sectional side elevation view of an alternative embodiment of the invention.

FIG. 15 illustrates an exploded view of a die assembly for forming an embodiment of the present invention.

FIG. 16 is a side cross-section of a section of the die assembly along lines 15-15.

FIG. 17 illustrates an exploded view of an alternative die assembly for forming an embodiment of the present invention.

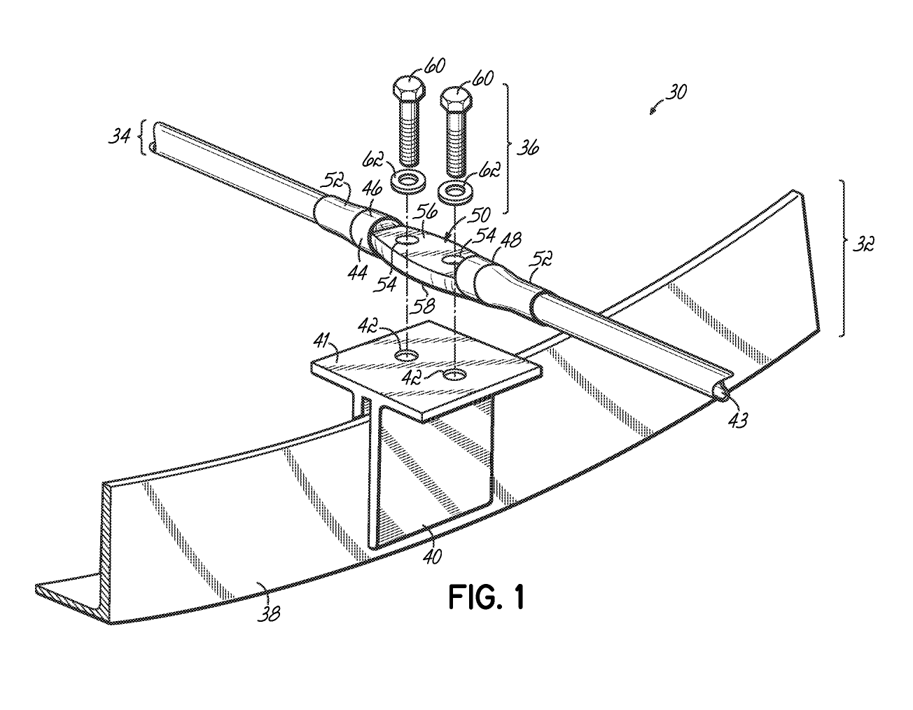

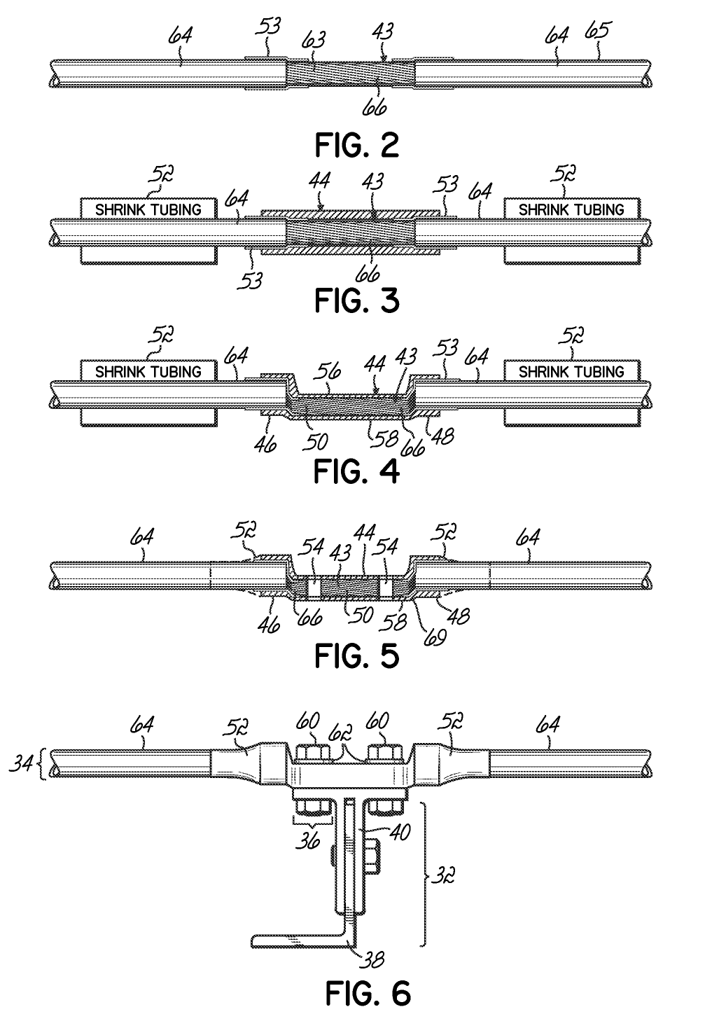

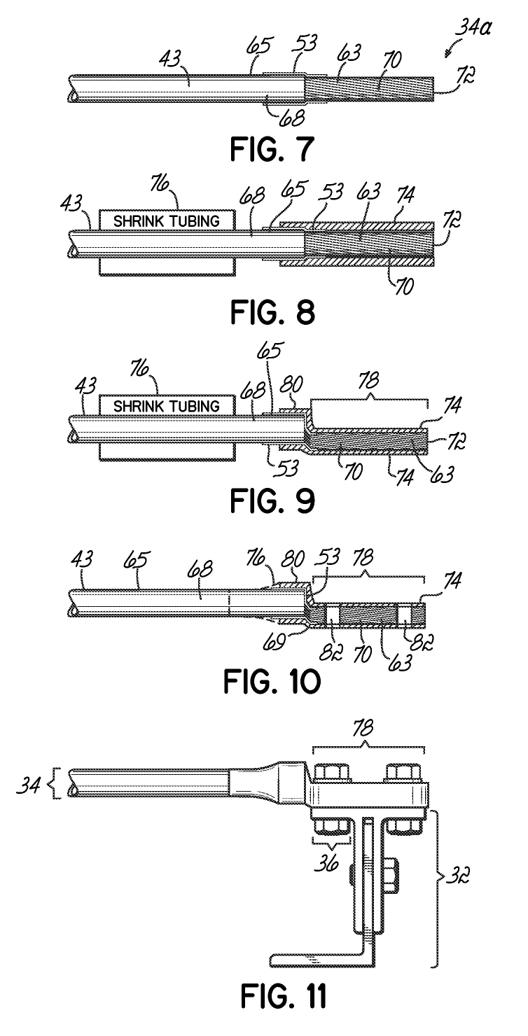

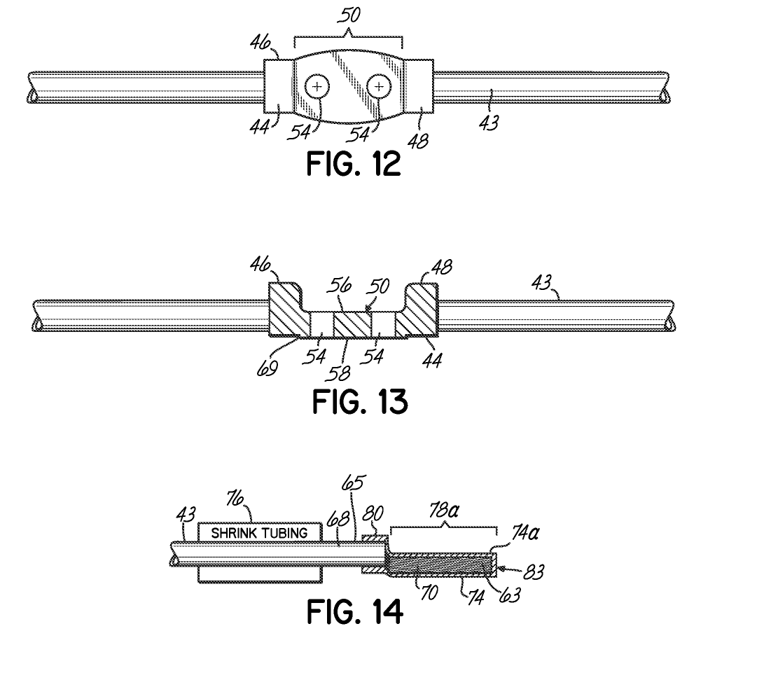

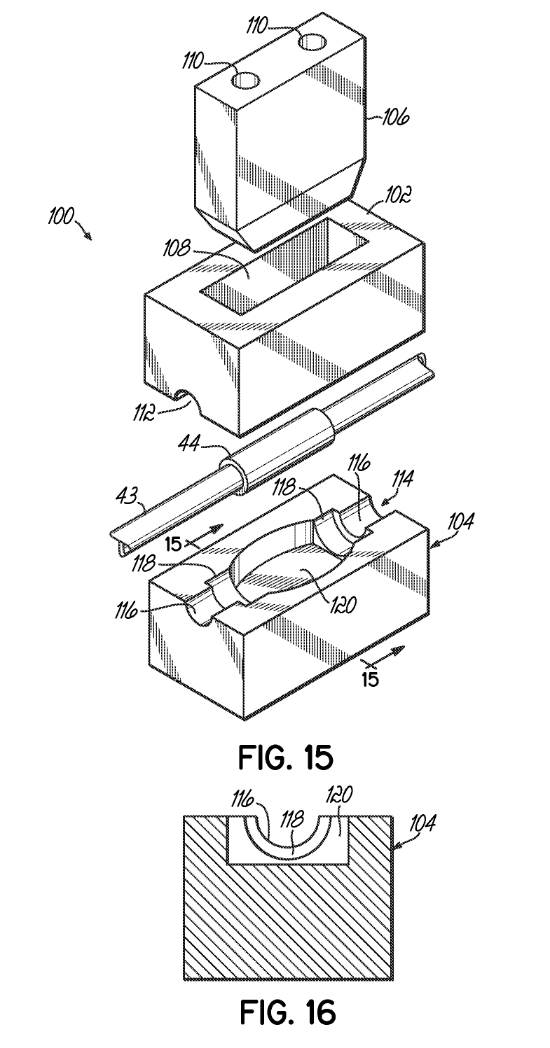

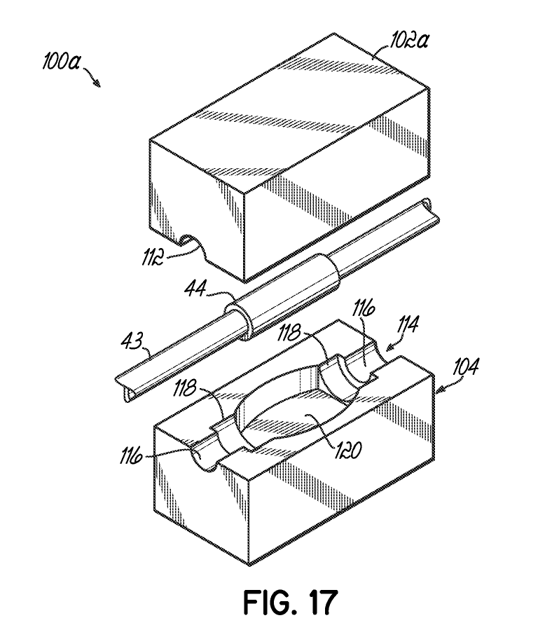

What is claimed is:

1. An assembly for forming an integral bonding attachment comprising:
a top die block;
a bottom die block actively mateable with the top die block;
a channel formed in at least one of the die blocks to receive a section of a conductive wire and a sleeve covering the conductive wire section;
the channel configured, such that when the top and bottom die blocks are actively mated the conductive wire section and sleeve are formed to make a flattened section encasing at least a portion of the wire section and at least one generally tubular section positioned at an end of the flattened section.

2. The assembly of claim 1 further including an anvil that is slidable in one of the die blocks, the anvil being slid to engage the wire section and sleeve when the blocks are actively mated.

3. The assembly of claim 1 wherein the channel includes a conductor area, a sleeve area and a flattening area, when the blocks are actively mated, a section of the sleeve being pressed in the flattening area to form the flattened section.

4. The assembly of claim 3 wherein the flattening area is generally oval-shaped.

5. The assembly of claim 3 wherein the sleeve area maintains a section of the sleeve generally non-flattened to form the at least one generally tubular section positioned at an end of the flattened section.
